(19) United States
(12) Patent Application Publication
(10) Pub. No.: US 2026/0098784 A1
(43) Pub. Date: Apr. 9, 2026

(54) CONTINUOUS ANOMALY DETECTION WITH A WIRELESS MONITOR DEVICE

(71) Applicants: Tractian Technologies Inc, Atlanta, GA (US); Tractian Limited, São Paulo (BR)

(72) Inventors: Andrei Alves Cardoso, São Paulo (BR); Leonardo Pereira de Almeida Campos, São Paulo (BR); Igor Vinicius Alvarenga Marinelli, Atlanta, GA (US); João Pedro de Carvalho Voltani, São Paulo (BR)

(21) Appl. No.: 19/354,582

(22) Filed: Oct. 9, 2025

Related U.S. Application Data
(60) Provisional application No. 63/705,444, filed on Oct. 9, 2024.

(51) Int. Cl. G01M 7/02; G01P 15/18

(52) U.S. Cl. CPC G01M 7/025; G01P 15/18

(57) ABSTRACT

A maintenance monitoring and recommendation infrastructure can include a plurality of monitors, which can be attached to various industrial equipment. The monitors can include a plurality of sensors and wireless and/or wired communication circuitry to transmit the sensor data to a receiver. The receiver can be connected to the maintenance monitoring infrastructure, where the sensor data can be used to perform maintenance data analysis and provide artificial-intelligence-based maintenance recommendations. In some embodiments, the monitors can be battery-powered and can configured with a continuous monitoring (CM) feature to detect maintenance-related events on a continuous-basis, while maintaining a robust life-expectancy for the monitors.

### CROSS-REFERENCE TO RELATED APPLICATIONS

This application claims the benefit of priority to U.S. Provisional Application No. 63/705,444, filed on Oct. 9, 2024, which is hereby incorporated by reference in its entirety.

### BACKGROUND

### Field

This invention relates generally to the field of maintenance monitoring devices and more particularly to battery-powered, portable maintenance devices with wireless communication capabilities.

### Description of the Related Art

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Industrial plants can include numerous mechanical machines with thousands of moving parts. To increase the efficiency of plant operations, the machines are monitored for maintenance purposes. Monitoring can include a trained technician visually inspecting the machines, observing the machine operations, and listening for any abnormal auditory cues that can indicate a present or potential maintenance-related fault in the machines. The technicians can also perform more sophisticated diagnosis, using maintenance and diagnostic tools. Continuous monitoring of industrial machines can present operational inefficiencies and cost to an industrial plant, particularly as the number of machines can be substantial in an industrial plant. For these and similar reasons, plants or busy shops with mechanical machines can benefit from an automated maintenance infrastructure. The automatic maintenance infrastructure can continuously collect maintenance-related data from various machines, detect maintenance-related events, and recommend appropriate action.

### SUMMARY

The appended claims may serve as a summary of this application. Further areas of applicability of the present disclosure will become apparent from the detailed description, the claims, and the drawings. The detailed description and specific examples are intended for illustration only and are not intended to limit the scope of the disclosure.

### BRIEF DESCRIPTION OF THE DRAWINGS

These drawings and the associated description herein are provided to illustrate specific embodiments of the invention and are not intended to be limiting.

FIG. 1A illustrates example diagrams of a monitor, industrial machines, and an infrastructure of fault monitoring and maintenance operations according to some embodiments.

FIG. 1B illustrates an exploded view of the monitor of the embodiment of FIG. 1A.

FIG. 2 illustrates two graphs to illustrate an example configuration of a continuous monitoring (CM) feature that reduces battery consumption of a portable monitor, while retaining the monitor's capability to monitor unscheduled high machine vibration events.

FIG. 3 illustrates a graph, where a CM feature includes a minimum time between sampling restriction.

FIG. 4 illustrates a flowchart of a method of configuring a continuous monitoring feature for the monitor of the embodiment of FIGS. 1 and 2.

### DETAILED DESCRIPTION

The following detailed description of certain embodiments presents various descriptions of specific embodiments of the invention. However, the invention can be embodied in a multitude of different ways as defined and covered by the claims. In this description, reference is made to the drawings where like reference numerals may indicate identical or functionally similar elements. Some of the embodiments or their aspects are illustrated in the drawings.

Unless defined otherwise, all terms used herein have the same meaning as are commonly understood by one of skill in the art to which this invention belongs. All patents, patent applications and publications referred to throughout the disclosure herein are incorporated by reference in their entirety. In the event that there is a plurality of definitions for a term herein, those in this section prevail. When the terms “one”, “a” or “an” are used in the disclosure, they mean “at least one” or “one or more”, unless otherwise indicated.

For clarity in explanation, the invention has been described with reference to specific embodiments, however it should be understood that the invention is not limited to the described embodiments. On the contrary, the invention covers alternatives, modifications, and equivalents as may be included within its scope as defined by any patent claims. The following embodiments of the invention are set forth without any loss of generality to, and without imposing limitations on, the claimed invention. In the following description, specific details are set forth in order to provide a thorough understanding of the present invention. The present invention may be practiced without some or all of these specific details. In addition, well known features may not have been described in detail to avoid unnecessarily obscuring the invention.

In addition, it should be understood that steps of the exemplary methods set forth in this exemplary patent can be performed in different orders than the order presented in this specification. Furthermore, some steps of the exemplary methods may be performed in parallel rather than being performed sequentially. Also, the steps of the exemplary methods may be performed in a network environment in which some steps are performed by different computers in the networked environment.

Some embodiments are implemented by a computer system. A computer system may include a processor, a memory, and a non-transitory computer-readable medium. The memory and non-transitory medium may store instructions for performing methods and steps described herein.

Industrial machines can benefit from consistent and accurate fault monitoring with artificial intelligence processing of the monitored data. In some embodiments, a plurality of small monitor assemblies, each equipped with wireless communication circuitry can be attached to various industrial machines in a plant. The monitors can sense and report various operational parameters related to fault monitoring. For example, temperature and vibration can be monitored and reported. The quality of vibrations, vibration trend data and other characteristics can be indicators of fault occurring or developing in an industrial machine. Similarly, temperature and temperature trends of a machine can include indicators of occurring or upcoming faults in the machine.

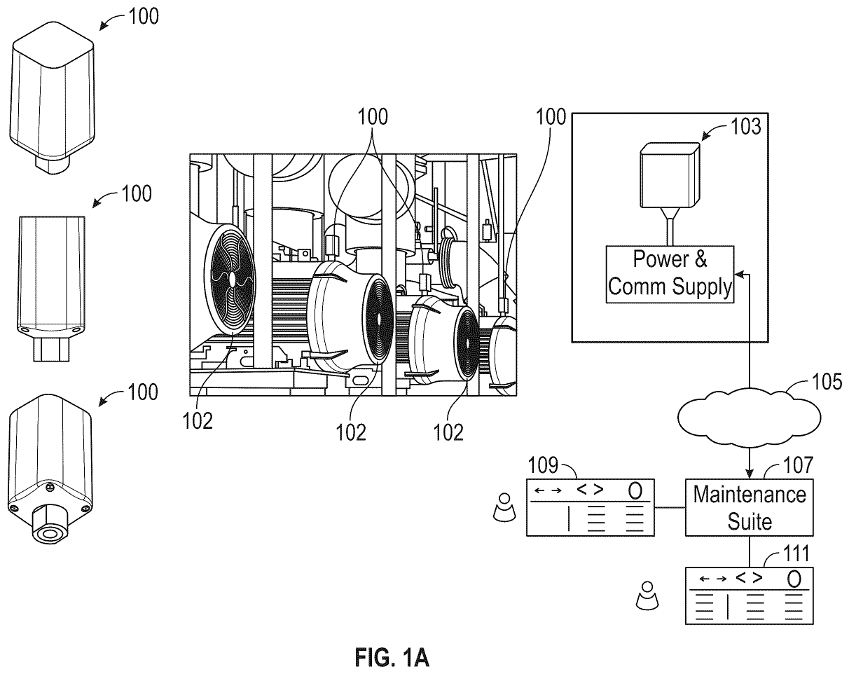

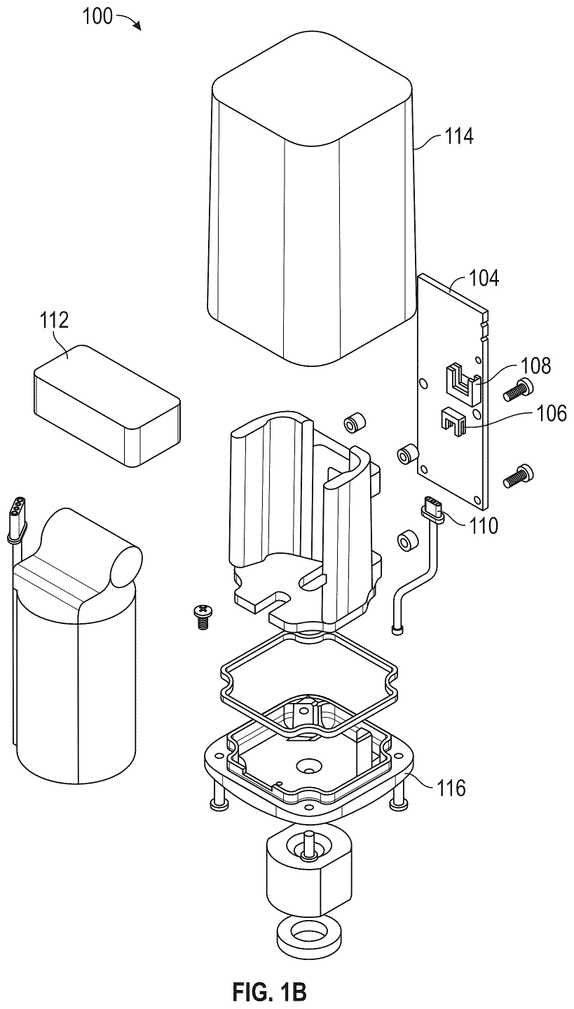

FIG. 1A illustrates example diagrams of a monitor 100, industrial machines 102, and an infrastructure of fault monitoring and maintenance operations according to some embodiments. The monitor 100 can be battery operated and can include a variety of sensing components enclosed in a housing. The monitor 100 can attach to machines 102 in the plant using a magnetic connection and/or by using other methods of attachment and fastening to secure the monitors 100 to machines 102 in the plant. The attachment of the monitors 100 to machines 102 can depend on the magnitude of the vibrations and other considerations related to the environment of the machines 102 and the plant. For example, if larger magnitude vibrations are expected, the connection between the monitors 100 and the machines 102 can be secured with an adhesive agent, so the monitors 100 can maintain their connections to the machines 102, despite large vibrations.

The monitors 100 can include wireless communication circuitry and can be in wireless communication with one or more receivers 103. In some embodiments, one or more monitors 100 can be modified to be in wired communication with a receiver 103 and have a connection to an outlet source of power. In other words, the source of power and type of communication of the monitors 100 can be modified, depending on the application and the environment of the plant to include any combination of battery-operated, outlet-operated, wired communication, and wireless communication. Similarly, the receivers 103 can include both wired and wireless communication circuitry. The receivers 103 can also be powered with or without the use of a battery. In some embodiments, both the monitors 100 and the receivers 103 can wirelessly communicate to a portable computer, such as a laptop, a smart phone, a smart tablet, or other portable devices, in the field, using a local or cellular wireless network.

The numbers and locations of the receivers 103 can depend on the size of the plant and then numbers and distances of the monitors 100, relative to the receiver 103 and the wireless communication technology used to communicate between the monitors 100 and the receiver 103. The receivers 103 can be mounted at various locations in a plant and can have connection to a power and a communication source. For example, the receivers 103 in a plant can be in wired and/or wireless communication to one or more communication portals 105. Example communication portals 105 can include a local network, the Internet, one or more cloud infrastructures, gateways, other receivers 105, and other communication midpoints, or endpoints. The receivers 103 can transmit the fault monitoring data for upstream processing. The receivers 103 can also receive various operational configuration files, settings files, and/or other operating parameters and can transmit the operating parameters to the monitors 100. Examples operating parameters can include various timing and frequency of when and how the monitors 100 should collect data from the machines 102.

A maintenance suit 107 can receive monitoring data from the monitors 100 and perform processing related to fault monitoring and maintenance operations on the data. The maintenance suite 107 can include a variety of submodules and databases that can support processing of the monitoring data, including, storage of the data, generating reports from the data, extracting trends from the data, generating fault prediction from the data, generating maintenance action items, tickets, generating alerts, and/or other automated actions related to the maintenance of the machines 102. In some embodiments, the operations of the maintenance suite 107 can include artificial-intelligence submodules that can assist in fault prediction, maintenance recommendation pattern and trend detection, and other data analytics action, augmented or generated by artificial intelligence models. Example artificial intelligence techniques and/or models used by maintenance suite 107 can include neural networks, deep neural networks, machine learning, convolutional neural networks (CNNs), random forests, and others.

The maintenance suite 107 can support a variety of user interfaces (UIs). For example, the maintenance suite 107 can support a frontend user interface 109 and a backend user interface 111. Various parameters related to the operation of the monitors 100 can be viewed and/or modified via the user interfaces 109, 111. The user interfaces 109, 111 can provide access for a user to generate or modify configuration files, settings and operating parameters for the monitors 100 and the maintenance suite 107. The users can also view the output of the maintenance suite 107 via the user interfaces 109, 111.

While not shown, the monitors 100 are not the only maintenance-related in-field components operated by the maintenance suite 107. Other components associated with monitoring and maintenance of the machines 102 and the plant can also be in communication with the maintenance suite 107. For example, in some embodiments, energy management components in communication with the maintenance suite 107, can monitor the power consumption of the machines 102 and their plant.

Depending on the size of an industrial plant, the monitors 100 can be numerous, for example in the hundreds or thousands. The maintenance suite 107 can streamline and track data from hundreds or thousands of machines and automate the identification and tracking of maintenance-related tasks for a large industrial plant, having hundreds or thousands of machines.

FIG. 1B illustrates an exploded view of a monitor 100. Some example components include the printed circuit board (PCB) 104, the microcontroller 106, an accelerometer 108, a temperature sensor 110, a battery module 112, various spacers, holders, internal conduits, and a housing 114. The housing 114 can house the internal components of the monitor 100. A housing lid 116 can enclose the housing 114 and seal the internal components of the monitor 100 from the outside. The monitor 100 can be made water-, dust- and particle-resistant by a variety of techniques. For example, in some implementations, the monitor 100 can be resin-coated. The battery module 112 can include one or more lithium-ion batteries, and a battery management system (BMS). In other embodiments, the BMS can be external to the battery module 112, for example, it can be mounted on the PCB 104. In some embodiments, the life expectancy of the battery module 112 can be between three to five years.

The monitor 100 can include communication circuitry, corresponding to the communication circuitry of one or more receivers, for example, the receivers 103, and one or more local, private and/or public communication network, including one or more cellular networks. The choice of network and communication circuitry can depend on the size of the plant and the distance of the monitor 100 from a receiver 103. The communication circuitry of the monitor 100 can be mounted on the PCB 104. In some embodiments, the communication circuitry may be integrated in the microcontroller 106. Similarly, in other embodiments, various components can be combined into one or use a component that integrates several components together. The monitor 100 can include a magnetic collar to provide magnetic attachment between the monitor 100 and the machine 102. In some embodiments, the temperature sensor 110 can be routed to a surface very near the point of contact between the monitor 100 and the machine 102 to provide a more accurate reading of the temperature of the machine 102.

The accelerometer 108 can be a micro-electro-mechanical system (MEMS) accelerometer, capable of one, two, or three axis acceleration data. For example, in some embodiments, the accelerometer 108 can measure forces in three directions along the XYZ axes. The accelerometer 108 can measure and transmit both magnitude and spectral data of the vibrations of a machine 102 to the microcontroller 106.

The microcontroller 106 can be a collection of various components, including computer or computing components. Example components of the microcontroller 106 can include a processor, such as a central processing unit (CPU), permanent and impermanent memory, including for example, random access memory (RAM) of various kinds, solid state, flash or other permanent memory, interconnects, buses and communication vias between the various components. In some embodiments, the microcontroller 106 can include external communication circuitry to enable wireless communication, including radio frequency identification (RFID), Bluetooth, cellular, or other communication technologies. In other embodiments the monitor 100 can include dedicated wireless communication circuitry, fabricated or included in the monitor 100, in a separate component than the microcontroller 106.

The monitors 100 can be configured to spend the majority of their time in hibernation state to conserve battery power. In hibernation mode, the power to all or some of the components of the monitor 100 can be reduced or minimized, thereby reducing the overall battery consumption in the hibernation state. The monitors 100 can be configured to periodically exit hibernation mode and enter normal operation mode, where power and functionality to some or all components is restored. For example, the monitors 100 can perform periodic sampling of various operational parameters of the machines 102, such as temperature and vibrations. When scheduled sampling is not performed, the monitors 100 can be in hibernation mode.

The monitors 100 can perform a variety of samplings of machine operation parameters. For example, for the vibration parameter of the machines 102, the monitors 100 can perform various samplings at different intervals and with different characteristics. Example sampling characteristics can include sampling intervals, sampling frequency, sampling rate, sampling range, sampling resolution and other characteristics. Sampling interval can refer to the period by which the monitor 100 turns ON and performs a sampling with a selected set of sampling characteristics. In some embodiments, the monitors 100 can be configured to perform scheduled sampling sessions, which are samplings performed at selected intervals. The selected intervals can depend on the type of machines 102 and other factors that are application-dependent, based on where the monitors 100 are used. Example sampling intervals can include sampling with intervals separated by minutes, hour or hours, days, or even months, and other intervals.

Sampling machine characteristics provide more insight into the maintenance posture of a machine when the sampling of the characteristics, such as vibration and temperature, is performed when the machine is turned ON and is operating. Scheduled sampling can be beneficial to obtain a maintenance picture of machines that run somewhat continuously or on a predicted basis. Some industrial machines 102, on the other hand, can have unpredictable run time schedules, or no schedule at all. For example, some computer numerical control (CNC) machines are only turned ON when a worker is using the machine. Furthermore, even for machines that are continuously ON, maintenance-related events and changes in the operating characteristics of the machine, can occur at a time between two intervals of a scheduled sampling, and thus be missed. Consequently, a robust maintenance monitoring procedure can benefit from a continuous monitoring (CM) feature, which can perform sampling when a maintenance-related event is detected. At the same time, continuous monitoring can increase the power consumption of the monitoring device. The described embodiments include configuring the monitors 100 with a CM feature in a manner that does not substantially impact the life-expectancy of the battery module 112, by conserving and regulating the battery usage, introduced by the CM feature, while at the same time being able to perform sampling during a potential or actual maintenance-related event.

In some embodiments, the monitors 100 can perform both scheduled sampling and CM sampling. While the embodiments will be described in relation to the vibration sampling, the described techniques related to configuring the monitors 100 for the CM feature can be extended to sampling other maintenance-related parameters, and machine characteristics, such as temperature and others.

In some embodiments, the CM feature includes performing continuous, low resolution and low-power sampling, until a maintenance-related event is detected. An example of a maintenance-related event is an unusual vibration in the typical vibration profile of a machine. Once a maintenance-related event is detected, the CM feature can place the monitor 100 in a high-resolution, high-power mode to perform robust sampling. The CM feature can also switch the monitor 100 to high-resolution, high-power mode, when vibration samples during the low-resolution session indicate the machine has been turned On. In other words, the CM feature can configure the monitor 100 to operate in two modes, the low-power mode, and the high-power mode. The low-power mode is when the monitor 100 performs a continuous sampling of the machine vibrations, albeit, at sampling characteristics, configured to prioritize low battery consumption, while gathering sufficient samples to detect a shift in vibrations, indicating the machine turning ON, or registering an unusual vibration event that can be maintenance-related. The high-power mode configures the monitor 100 to perform robust vibration sampling, gathering sufficient sampling data for more reliable downstream analysis. The precise sampling characteristics during the low- and high-power modes depend on the characteristics of the machines 102 and the environment and are application-dependent. The low-power mode can also be referred to as the low-resolution mode. Similarly, the high-power mode can be referred to as the high-resolution mode. However, other sampling characteristics, besides resolution, can be more robust in high-power mode, compared to the low-power mode.

During both scheduled sampling and samplings triggered by the CM feature, the monitor 100 utilizes the accelerometer 108 to sample vibrations of a machine 102. The microcontroller 106 can receive the samples from the accelerometer 108, perform processing and store or transmit the samples. During scheduled sampling, and also when triggered by the CM feature, the monitor 100 can be in high-power consumption mode, to perform robust sampling. In addition to higher resolution, other sampling characteristics can also be collected more robustly, for example, a higher range, higher frequency, and higher sampling rate may be used. More robust sampling, including higher resolution sampling, can collect more data for further downstream processing to determine a more accurate picture the maintenance posture of the machine. After a scheduled sampling session, the monitor 100 can be placed in hibernation with the CM feature triggering the next wakeup event, or a next scheduled sampling interval triggering a wakeup event for the monitor 100. After a wakeup event, the monitor 100 transitions from hibernation to active or normal mode, where a high-power mode sampling session can be performed.

The sampling characteristics for the scheduled sampling sessions, and the CM feature can be outlined in one or more sampling configuration files, obtained from a user via a dashboard, or generated by artificial intelligence techniques, using historical data from a machine 102, or generated by other techniques. The sampling characteristics stored in one or more sampling configuration files can configure the accelerometer 108 to perform sampling according to the one or more sampling configuration files. For example, the accelerometer 108 can be configured to perform high-power mode sampling at selected intervals, thereby performing scheduled sampling. The accelerometer 108 can be configured to perform continuous low-power mode sampling, independent of the high-power mode sampling intervals. In other words, the CM feature running between the scheduled sampling intervals can include the accelerometer 108 performing low-power sampling, until a next scheduled sampling session or until the CM feature triggers a high-power sampling session. As an example, low resolution sampling during low-power mode can include sampling at a few Hertz (e.g., 12.5 Hz), while high resolution sampling during high-power mode can be several hundred or thousands orders of magnitude larger than the low-resolution sampling (e.g., sampling frequency at 32 KHz).

The CM feature can include a detection threshold, below which the accelerometer 108 operates in low-power mode, collecting low-resolution vibration samples. The detection threshold can include a magnitude of vibration measured in units of g-force, acceleration, gravity, or another related metric. The detection threshold can also be industry- and application-dependent. For example, in some embodiments, the detection threshold is 1 g. Furthermore, the detection threshold can be derived using artificial intelligence, statistical analysis, heuristic, or by other techniques. When the magnitude of vibrations, detected by accelerometer 108, is below the detection threshold, the accelerometer continues to sample vibrations of the machine in low-power mode. When the measured vibrations exceed the detection threshold, the accelerometer can transition to high-power mode, performing more robust sampling.

In some embodiments, the transition from low-power mode to high-power mode can be delayed for an amount of time, referred to as delay period. The delay period can be a user-configurable or automatically configurable parameter. The period of delay allows for passage of transient vibrations before collecting high resolution sampling, thereby increasing the quality of the collected samples. For example, some industrial machines when transitioning from OFF to ON mode can generate transient vibrations that are not necessarily helpful for determining maintenance posture of the machine. The period of delay allows for the passage of the transient vibrations and for the machine to settle in its typical vibration profile, before sampling vibrations. The period of delay can be automatically determined using historical vibration trend data, or other techniques.

In some embodiments, to determine whether the low-resolution samples, collected during low-power mode, the accelerometer can generate three consecutive samples and compare the difference in magnitude between the first and second with the magnitude of the third sample. When the difference is below the detection threshold (e.g., below 1 g), the accelerometer continues to remain in low-power mode, performing low-resolution sampling (e.g., sampling at 12.5 Hz). When the difference is equal to or above the detection threshold (e.g., above 1 g) the accelerometer can transition to high-power mode (e.g., sampling at 32 KHz). In some embodiments, various sampling characteristics can be more robust between the low-power mode and high-power mode. For example, during low-resolution sampling, accelerometer 108 can sample vibrations up to a maximum magnitude of +/−1 g. In this scenario, the selected sampling range, or magnitude, can be the same as the detection threshold. However, in other embodiments, the low-resolution sampling range, or maximum magnitude, can be a different value than the detection threshold. During high-resolution sampling in the high-power mode, the sampling range can increase to a range between +/−16 g, or several folds larger than the low-power mode sampling range.

To conserve battery power, while at the same time equipping the monitor 100 with CM feature, the battery consumption of the monitor 100 can be coupled with the detected vibrations of the accelerometer 108. For example, activating the CM feature for a monitor 100 can cause the monitor 100 to enter hibernation state, with only select components of the monitor 100 remaining in active state to perform low-power mode sampling. As an example, during low-power mode, battery power to the printed circuit board (PCB) 104 and associated components can be reduced or shut off, except for a selection of components, related to collecting vibration samples and determining whether the vibration samples have exceeded the detection threshold. Example components that can remain active, albeit, in low-power mode, include the accelerometer 108 and a comparator circuit to determine whether the vibrations have exceeded the detection threshold. Components, such as other sensors, communication circuits and microcontroller 106 can be in hibernation, during low-power mode operations. In some embodiments, instead of utilizing a comparator circuit, the microcontroller can operate partially or in low-power mode, providing a processor to detect whether the detection threshold has been exceeded.

When the accelerometer registers vibrations above the detection threshold, the power to some or all components of mounted on the printed circuit board 104 can be restored. These components, together with the accelerometer 108 can perform high-power mode sampling.

In some embodiments, the microcontroller 108 includes a wakeup circuitry, which can be configured to power on the microcontroller 106 from hibernation state, upon detecting a wakeup event. The wakeup event can include the beginning of a scheduled sampling session and receiving a CM feature trigger event. The CM feature trigger event includes the accelerometer reporting vibrations exceeding the detection threshold. In some embodiment, the wakeup circuitry can be implemented using a backup real-time clock (RTC) module of the microcontroller 106. Before hibernation, the microcontroller 106 can configure the RTC with one or more alarms. The alarms can wake up the microcontroller 106 from hibernation. The alarms can be configured to trigger with the beginning of a scheduled sampling session and by an indication of the accelerometer reporting vibration samples exceeding the detection threshold in magnitude.

In some embodiments, the microcontroller 106 can include a comparator, or similar circuit, which can continuously receive consecutive samples from the accelerometer 108, and determine whether the vibrations have exceeded the detection threshold. The comparator, or similar circuit, can receive first, second and third consecutive samples. The comparator, or similar circuit, can obtain the difference in the magnitudes of the first and second samples and compare the difference with the magnitude of the third sample. When the difference is above the detection threshold, the comparator, or a similar circuit, can trigger an RTC alarm. The comparator, or similar circuit to perform the comparison operation can also be implemented or be included as part of the accelerometer 108 or can be a separate component in mounted on the printed circuit board 104.

Upon waking up, the microcontroller 106 can begin executing a configuration file, which can include restoring power to the rest of the printed circuit board 104, including other sensors, communication circuitry, and memory modules. The microcontroller 106 can place the accelerometer in high-power sampling mode, where the accelerometer can increase the robustness of the sampling, by for example, increasing the sampling acquisition frequency, performing longer sampling sessions, acquiring samples at larger sampling range and larger sampling resolution.

In some embodiments, a configuration of the CM feature includes using the low-power samples obtained from the accelerometer 108 to determine whether the machine vibrations have exceeded the detection threshold. When the machine vibrations have exceeded the detection threshold, the accelerometer 108 is placed in high-power, high resolution sampling mode, after a configurable period of delay. The high-power high-resolution sampling mode can last for a configurable duration. After obtaining the high-resolution sampling, the accelerometer is turned OFF to prevent the accelerometer from immediately triggering another high vibration event in the machine and unnecessarily performing multiple high-resolution sampling, draining the battery module 112. During the next scheduled sampling session, the machine vibrations are checked against the detection threshold. When the machine vibrations are still above the detection threshold, the accelerometer 108 is kept OFF. When the machine vibrations are detected to be below the detection threshold, the accelerometer 108 is turned ON in low-power, low-resolution mode to detect future machine vibrations above the detection threshold.

Stated otherwise, the CM feature is turned OFF, and the accelerometer is turned OFF after a CM detection event. The subsequent scheduled sampling sessions are used to determine whether the machine vibrations have fallen below the detection threshold, so as to not immediately trigger another CM detection event. When the subsequent scheduled sampling sessions determine that the machine vibrations are below the detection threshold, the CM feature is turned ON, and the accelerometer 108 is placed in low-power, low-resolution mode to continue monitoring for potential, future machine vibrations, above the detection threshold. With this configuration of the CM feature, high machine vibrations that occur outside of the scheduled sampling sessions are detected while the battery consumption due to the CM feature is reduced.

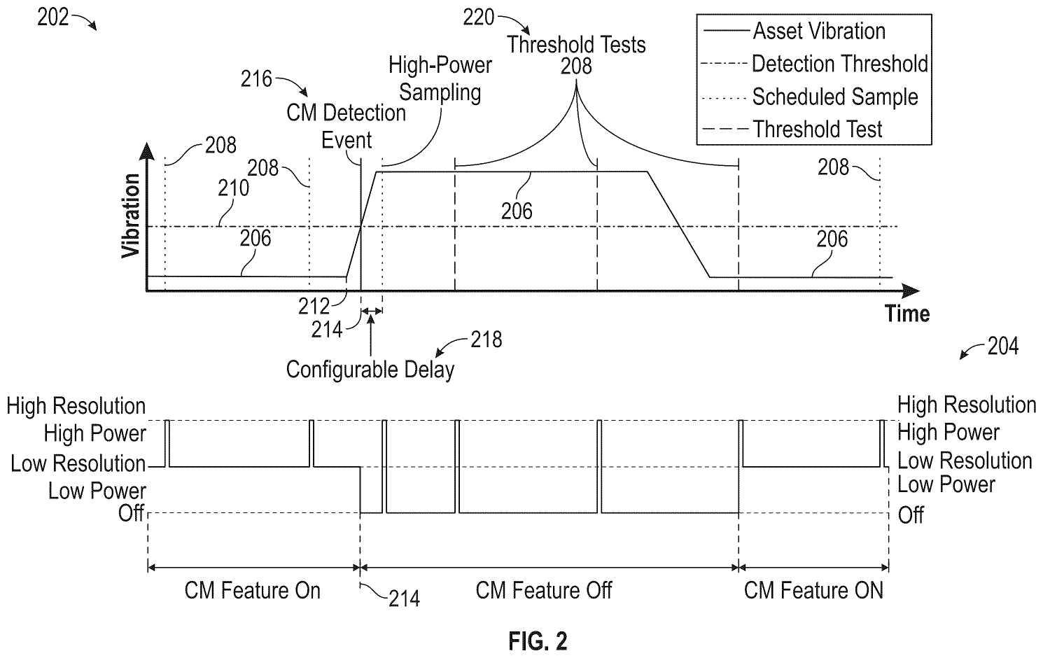

FIG. 2 illustrates two graphs 202, 204 to illustrate an example configuration of a continuous monitoring (CM) feature that reduces battery consumption, while still monitoring to unscheduled high machine vibration events. The graph 202 illustrates an example vibration profile of a machine 102, where machine vibrations 206 are graphed over time. On the x-axis time is shown, and the y-axis vibrations are shown. The graph 204 illustrates the power profile, and a corresponding sampling mode, in which the accelerometer 108 is placed and configured. The x-axis shows time, and the y-axis shows the power mode of the accelerometer 108.

During the scheduled sampling sessions 208, the accelerometer 108 is configured to perform high-power, high-resolution sampling. Consequently, the accelerometer 108, regardless of its prior state, is transitioned to the high-power mode, high resolution sampling mode at the beginning of a scheduled sampling session 208. In the example shown, initially, the CM feature is ON, and the accelerometer is in low-power mode, sampling machine vibrations 206 at low-resolution. The machine vibrations 206 are compared against a detection threshold 210. At time 212, the machine vibrations 206 begin rising. At time 214, the machine vibrations 206 rise above the detection threshold 210, which triggers a continuous monitoring (CM) detection event 216. After the CM detection event 216, the accelerometer 108 can be placed in OFF mode and the CM feature can be turned OFF. After a configurable period of delay 218, the accelerometer 108 can be placed in high-power mode, performing high resolution sampling for a configurable duration. The duration of the high-power mode can be the same as a scheduled sampling session or other durations. Turning OFF the accelerometer 108 after a CM detection event 216 can prevent multiple and immediate high-resolution sampling by the accelerometer 108, unnecessarily draining the battery module 112.

The configurable period of delay 218 can be user-defined and/or derived from other techniques, such as heuristics, machine learning, pattern detection, historical data analysis and others. The configurable period of delay 218 can be as low as zero, and as high as several days (e.g., 50 days, etc.).

After the high-power mode sampling due to the CM detection event 216, subsequent scheduled sampling sessions 208 are performed according to their configuration. Subsequent sampling sessions 208 can be used to perform a threshold test 220. The threshold test 220 can include determining whether the machine vibrations 206 are still above the detection threshold 210. When during a scheduled sampling session 208, it is determined that the machine vibrations 206 have fallen below the detection threshold 210, the CM feature is turned back ON, which causes the accelerometer 108 to turn ON and perform low-power, low-resolution sampling. In the example shown, during the first and second scheduled sampling sessions 208 after the CM detection event 216, the machine vibrations 206 are still above the detection threshold 210. Consequently, the CM feature is kept in OFF mode. The accelerometer 108 is also in OFF mode, except for when performing high-power mode sampling during the scheduled sampling sessions 208. In the example shown, during the third sampling session 208 after the CM detection event 216, the threshold test 220 determines the machine vibrations 206 are above the detection threshold 210. Consequently, the CM feature is turned ON, which causes the accelerometer 108 to turn ON and perform low-power sampling.

In the example shown the high-resolution sampling attributes, as a result of a CM detection event 216, is shown to be similar or identical to the high-resolution sampling performed for scheduled sampling sessions. However, this is not a requirement in every embodiment, and the sampling, as a result of a CM detection event 216, can be configured differently and with different attributes, compared to the scheduled sampling sessions. Furthermore, while only one sampling session is shown, the monitor 100 can perform various sampling sessions with different attributes, any of which can be used in conjunction with the CM feature and the configuration profile illustrated in the graphs 202, 204.

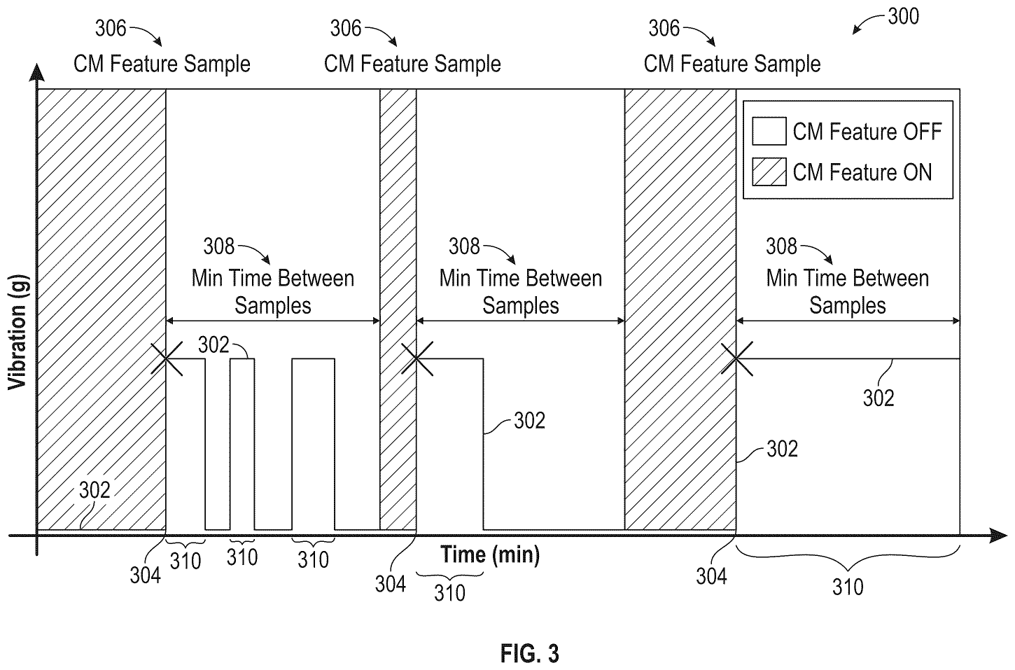

In some embodiments, to reduce or prevent repetitive sampling events after a CM detection event 216, the accelerometer 108 can be configured to not perform a high-resolution sampling for a period of time, or to be OFF for a period of time, after a high-resolution sampling event following a CM detection event 216. FIG. 3 illustrates a graph 300, where a CM feature includes a minimum time between sampling restriction. The graph 300 includes vibrations 302 in (g) plotted against time (minutes). At times 304, after CM detection events occur, the accelerometer 108 can perform high-resolution sampling, collecting CM feature samples 306. The CM detection events include the accelerometer 108 detecting machine vibrations above a detection threshold. After obtaining each CM feature sample 306, the accelerometer 108 can be configured to not perform any sampling or to be OFF for a period of time 308, referred to as minimum time between samples. In the example shown, the machine vibrations during windows 310 are not measured. Since these vibrations can all relate to the CM detection event, potentially reduced or minimal new information can be included in the machine vibrations occurring immediately after a CM detection event, or nearly after it. Consequently, ignoring these machine vibrations can contribute to saving battery power.

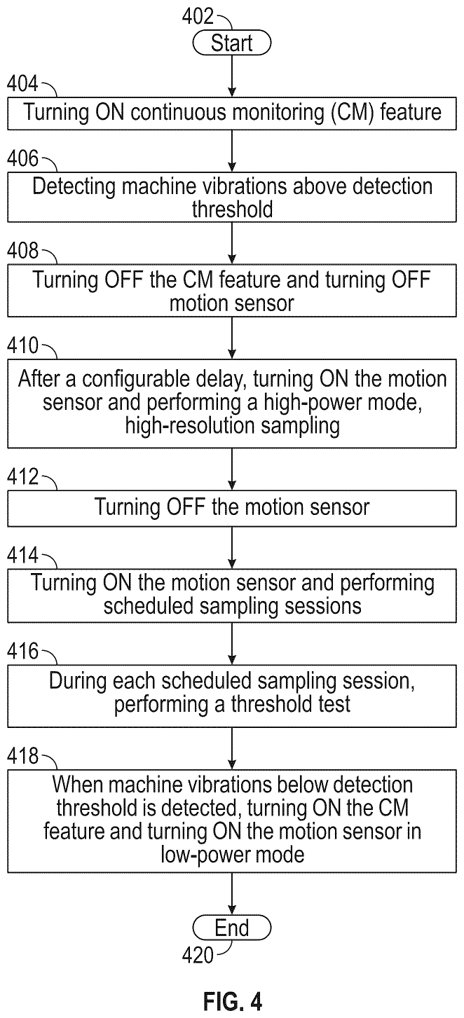

FIG. 4 illustrates a flowchart of a method 400 of configuring a continuous monitoring feature for a monitor 100. The method starts at step 402. Step 404 includes turning ON a continuous monitoring (CM) feature, which includes turning ON a motion sensor and performing low-power, low-resolution sampling with the motion sensor. Step 406 includes detecting machine vibrations above a detection threshold. Step 408 includes turning OFF the CM feature and turning OFF the motion sensor. Step 410 includes, after a configurable delay, turning ON the motion sensor, and performing a high-power mode, high-resolution sampling session. Step 412 includes turning OFF the motion sensor. Step 414 includes turning ON the motion sensor at the beginning of a scheduled sampling session, and performing high-power mode, high-resolution sampling sessions, and turning OFF the motion sensor at the end of a sampling session if the machine vibrations are above the detection threshold. Step 416 includes performing a threshold test during or at the end of a scheduled sampling session. Step 418 includes, when the machine vibrations are detected to be below the detection threshold, during a scheduled sampling session, turning ON the CM feature, and turning ON the motion sensor in the low-power mode, at the end of the scheduled sampling session. The method ends at step 420.

Some portions of the preceding detailed description have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “identifying” or “determining” or “executing” or “performing” or “collecting” or “creating” or “sending” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices.

Various general-purpose systems may be used with programs in accordance with the teachings herein, or it may prove convenient to construct a more specialized apparatus to perform the method. The structure for a variety of these systems will appear as set forth in the description above. In addition, the present disclosure is not described with reference to any particular programming language. It will be appreciated that a variety of programming languages may be used to implement the teachings of the disclosure as described herein.

While the invention has been particularly shown and described with reference to specific embodiments thereof, it should be understood that changes in the form and details of the disclosed embodiments may be made without departing from the scope of the invention. Although various advantages, aspects, and objects of the present invention have been discussed herein with reference to various embodiments, it will be understood that the scope of the invention should not be limited by reference to such advantages, aspects, and objects.

What is claimed is:

1. A method of monitoring an industrial machine comprising:
providing a monitor, comprising a microcontroller, a battery, a motion sensor, and communication circuitry, the monitor further comprising a housing enclosing the microcontroller, the battery, and the motion sensor, the motion sensor configurable to sample vibrations of a machine, at a sampling frequency, a selected range, and a selected resolution;
the microcontroller, configuring the motion sensor to sample machine vibrations at selected intervals, at a scheduled sampling frequency;
the microcontroller, configuring the motion sensor in a low-power mode, the low-power mode comprising the motion sensor sampling machine vibrations at a continuous sampling frequency;
the microcontroller entering hibernation mode;
the motion sensor, when detecting machine vibrations, having a magnitude above a detection threshold, transitioning, after a configurable delay period, from the low-power mode to a high-power mode, sampling the machine vibrations at a first sampling frequency when in the high-power mode;
the microcontroller further comprising a wake-up circuitry configured to receive a wake-up signal from the motion sensor when the motion sensor transitions from the low-power mode to the high-power mode, the microcontroller transitioning from hibernation mode to normal mode, when the wake-up circuitry receives the wake-up signal;
the motion sensor, after sampling the machine vibrations at the first sampling frequency for a selected duration, turning OFF;
during sampling of machine vibrations at a selected interval, the microcontroller, determining whether the machine vibrations are below the detection threshold; and
when the machine vibrations are determined to be below the detection threshold, during the sampling of the machine vibrations at the selected interval, transitioning the motion sensor from the OFF mode to low-power mode after completion of the sampling of the machine vibrations at the selected interval.

2. The method of claim 1,
wherein the microcontroller further comprises a printed circuit comprising internal components of the monitor, including the communication circuitry,
wherein the microcontroller in hibernation mode is configured to shut-off or reduce power supply to the printed circuit board, including the communication circuitry, except the microcontroller is configured to continue providing power to the motion sensor and the wake-up circuitry during hibernation.

3. The method of claim 1,
wherein during the low-power mode, the motion sensor is configured to sample machine vibrations at a continuous mode frequency, comprising a frequency lower than the high-power sampling mode frequency,
wherein the low-power mode sampling further comprises sampling machine vibrations at a lower range and lower resolution, compared to the high-power mode sampling range and resolution.

4. The method of claim 1 further comprising:
providing a receiver, the receiver comprising receiver communication circuitry;
the microcontroller, receiving the sampled vibrations from the motion sensor;
the microcontroller transmitting the sampled vibrations to the receiver; and
the receiver, receiving the vibrations via the receiver communication circuitry.

5. The method of claim 1, wherein the motion sensor detecting magnitude of machine vibrations above a detection threshold further comprises:
the motion sensor obtaining at least three consecutive samples, comprising a first, second and third; and
the motion sensor determining whether the third sample magnitude is greater than the difference between the first and the second sample magnitudes, by an amount greater than the detection threshold.

6. The method of claim 1,
wherein the microcontroller is configured to turn OFF the motion sensor, after detection of a machine vibration above the detection threshold, for a period comprising minimum time between samples.

7. The method of claim 1, wherein the motion sensor comprises a MEMS accelerometer.

8. The method of claim 1, wherein the scheduled sampling frequency is a high-resolution sampling frequency.

9. The method of claim 1, wherein the motion sensor comprises an accelerometer configured to measure force in three axes.

10. The method of claim 1, wherein the configurable period of delay is set to zero.
